(19) United States
(12) Patent Application Publication
(10) Pub. No.: US 2007/0122528 A1
(43) Pub. Date: May 31, 2007

(54) FROZEN CONFECTIONERY ITEM AND PROCESS FOR PREPARING

(76) Inventors: Philip Ignor Cathenaut, Ecouen (FR); Veronique Cossin, Beauvais (FR); Bruno Delande, Marseille en Beauvaisi (FR)

Correspondence Address: BELL, BOYD & LLOYD LLP, P.O. Box 1135, CHICAGO, IL, 60690, US

(21) Appl. No.: 11/668,315

(22) Filed: Jan. 29, 2007

Related U.S. Application Data
(62) Division of application No. 10/299,734, filed on Nov. 20, 2002, now abandoned.
Application No. 10/299,734 is a continuation of application No. PCT/EP01/06146, filed on May 30, 2001.

(30) Foreign Application Priority Data
May 31, 2000 (EP) 00201932.1

(51) Int. Cl. A23G 3/20

(52) U.S. Cl. 426/100; 426/621; 426/660

(57) ABSTRACT

A molded item of frozen confectionary based on water ice with a soft texture in the center. The item includes a center of water ice containing 32.5 to 40% by weight of dry matter and having a degree of overrun of 30 to 50% and whose texture is similar to that of an extruded ice cream. It also includes a wafer protected from moisture at least on its surface which is in contact with the center of the water ice, by a barrier layer. In this way, the wafer is formed to constitute a mold containing the center.

### CROSS-REFERENCE TO RELATED APPLICATIONS

This application is a continuation of the US national phase designation of International application PCT/EP01/06146 filed May 30, 2001, the entire content of which is expressly incorporated herein by reference thereto.

### TECHNICAL FIELD

The invention relates to the field of molded items of frozen confectionery based on water ice. It relates more particularly to a molded item of frozen confectionery based on water ice with a soft texture in the center.

### BACKGROUND ART

Iced confectionery articles of the water ice type are generally manufactured by filling a composition for water ice which is liquid at positive temperature, about 2-3° C., into molds generally made of heat-conducting metal circulating in refrigerant surroundings which cause the composition for water ice to freeze slowly by conduction. The refrigerant surroundings can be a bath of liquid refrigerant, for example brine, or a freezing tunnel with a cold-air flow in which the molds circulate.

Once frozen, the articles can be left in the molds which, at the same time, are used as packaging, for example in the case of small cylinders with a “push-up” device or pliable cases in the form of a cylinder flattened at one of its ends.

It is also possible to insert a stick into the mass of the iced composition which has not yet solidified through to the core, to continue the solidification, to de-mold the articles by heating the outer surface of the mold, to harden them and then to wrap them, for example in soft sachets or “flow-packs”.

Such molded articles generally have a hard texture due to the slow and progressive freezing by conduction, which articles having a soft texture are known, which consist, in particular, of a core of extruded overrun ice-cream coated with a composition of water ice. These are described, for example, in EP-A-0710074 or WO-A-9804149. The soft texture of the coating is obtained in these processes by immersing the pre-cooled extruded core in a composition for water ice and cooling very rapidly to a temperature <−15° C., for example, by dipping in liquid nitrogen so as to harden the coating. It is generally necessary to carry out several successive cycles of dipping and hardening in order to obtain the desired coating thickness.

While these products are useful, it would be desirable to have an iced confection that has a supple texture, and the present invention now satisfies this need.

### SUMMARY OF THE INVENTION

The invention proposes to provide a molded item of frozen confectionery based on water ice whose center has a soft texture and constitutes the filling for a wafer serving as mold for it.

The frozen confectionery item of the invention comprises:

i) a center of a water ice containing 20 to 40% by weight of dry matter, having a degree of overrun of 20 to 80% and whose texture is similar to that of an extruded ice cream, and

ii) a wafer protected from moisture at least on its surface which is in contact with the center of the water ice, by a barrier layer, and in which the wafer is formed to constitute an edible mold which contains the water ice center.

This product is preferably made by a process which comprises shaping a wafer to serve as a mold that is open at one or both of its ends to receive the frozen confection therein; coating a moisture barrier upon internal surface(s) of the wafer mold in an amount sufficient to retard moisture penetration of the wafer; and introducing into the wafer mold a water ice composition having a degree of overrun of 20 to 80% to form a center of the frozen confectionery item.

### BRIEF DESCRIPTION OF THE DRAWING

FIG. 1 is a schematic representation of the process of the present invention.

### DETAILED DESCRIPTION OF THE PREFERRED EMBODIMENTS

One feature of the water ice center is that it contains a stabilizer with gelling properties which may be chosen from carob gum, guar gum, tara gum, carboxymethyl cellulose, gelatin, alginates, carrageenan, starches, pectins, microcrystalline cellulose or a mixture of such ingredients.

Xanthan gum, carob gum, gelatin and pectins and more specifically a mixture comprising xanthan gum and carob gum, wherein the xanthan gum is predominant, or comprising gelatin and carob gum, wherein the gelatin is predominant, are preferably used.

The proportion of stabilizing mixture is < or =0.5% by weight and preferably 0.3 to 0.4% by weight.

The nature and the proportion of the stabilizing mixture in combination with the content of dry matter in the center allow it to be able to be treated and to be given a degree of overrun in the freezer and confer on it a texture similar to that of extruded ice cream leaving the freezer at about −5 to −60 C.

In the context of the invention, the degree of overrun may be defined as the increase in the volume of the mix due to the incorporation of air expressed in % by volume. It is preferably 30 to 50%.

Advantageously, the center has a proportion of dry matter of 28 to 32% by weight.

In addition to the stabilizing mixture, the dry matter of the center comprises:

from up to 20% by weight of fruit puree, flavoring or coloring, and from 20 to 27% by weight of carbohydrates, of which up to 7% by weight is glucose syrup. At least 1 and preferably 5 to 7% by weight is used.

It is thus possible to use a fruit puree or, as a variant, a fruit flavoring and a coloring.

In a preferred embodiment, the frozen confectionery item according to the invention is a frozen cone whose container is a wafer and whose center has a fruit-based color and flavor, and preferably contains a large quantity of fruit, in particular an extract, for example a fruit puree or a fruit flavoring.

As a variant of a wafer in the form of an open cone, it is possible to use a rolled-up hollow wafer constituting a tube or a taco shell, and in this case the wafer is open at the side and/or the both ends.

The soft center and its crisp container constitute a contrast of textures in the item.

The center may contain inclusions, dry or candied fruit pieces, gel, fondant, croquant, sauce, caramel, chocolate, sweetened confectionery or biscuits and, advantageously, preferably fruit pieces or fragments, for example of the same fruit contained, for example in puree form, in the mass of the center. In this context, the inclusions may be of sizes ranging from 0.1 to 10 mm.

The wafer does not serve solely to maintain the shape of the product, but also contributes to the taste sensation of the item.

The wafer should be protected from moisture uptake and re-uptake by a coating that is present at least on the surface of the wafer that is in contact with the filling or center. The wafer may be coated with a fatty composition such as a coating of chocolate or of compound. The coating composition in question may contain additions such as dry fruit pieces or toasted or puffed cereal particles, if desired.

The invention also relates to a process for preparing a composite item of frozen confectionery as described herein, in which:

a wafer which has been shaped and which serves as a mold, and which is open at one end or at both of its ends, and in which at least the internal surface is coated with a moisture barrier layer is provided, and

a water ice composition having a degree of overrun of 20 to 80% constituting the center of the item is introduced into the open wafer. The coating prevents the center from contacting the wafer to preserve the properties of the wafer in the final product.

According to a particular embodiment of the process for preparing a preceding composite item of frozen confectionery, the center is manufactured by introducing therein inclusions having a size ranging from 0.1 to 10 mm, and it is cooled before being introduced into the wafer.

According to a second particular embodiment of the process for preparing a preceding item of frozen confectionery, the shaped wafer is filled with a water ice composition having a degree of overrun of 20 to 80% constituting the center of the item, and it is coated with a fatty composition.

In the case of cones, it is possible to supplement the filling with a decoration, for example in the form of a flame or a rose and to deposit therein, where appropriate, additions, for example in the form of particles or pieces which may be decorative.

In the case of tubes, cigars or taco shells, it is possible to close the two open ends of the wafer with caps, for example made of chocolate, which, in this case, may cover a portion of the external surface of the wafer so as to ensure better protection.

Regardless of the embodiment of the process, the measuring out of the water ice composition constituting the center of the item requires specific means which make it possible to fill the hollow wafer with a relatively hard and viscous material, which contains, where appropriate, inclusions of 0.1 to 10 mm in size.

The specific means for filling the wafer may be a distributing device connected to the freezer and kept under pressure by the freezer. This device is combined with a volumetric metering device comprising a metering chamber, in which the pressure allows the supply of the metering chamber.

In the context of the invention, a relatively hard material is a water ice at −2° C. to −6° C., and preferably at −5° C. to −6° C. This material has a degree of overrun leaving a freezer. Its texture is firmer and it has a percentage of frozen water relative to the total water in the recipe which is higher than a customary liquid composition to be frozen, this being marked to a greater or lesser degree according to the composition of the mixture to be frozen.

The specific means may be applied to any machine in which the wafers are transported on supports integrally attached to a conveyor in a pulsed air tunnel providing the deep freezing, it being possible for the conveyor to be rectilinear or to become rolled up, for example into a single or a double helix, flattened or revolving, or any machine of the preceding type in which the movement of the wafers is continuous or stepwise.

Thus, the specific means may be applied in a very simple manner to existing machines to obtain the improvements of the invention.

This principle of metering under pressure may be applied to various types of metering devices, such as metering devices with a distribution cock and with vertical or horizontal drums, metering devices with valves or, preferably for filling cones, metering devices with immersed nozzles of the “bottom-up filler” type combined with raising and lowering devices which are set to descend to an intermediate level, that is to say that they do not go as far as the bottom of the wafer cone.

When multiple channel metering is used, the ice is homogeneously divided between the various outlet conduits of the distributing device and may fill the metering chambers, without creating air pockets.

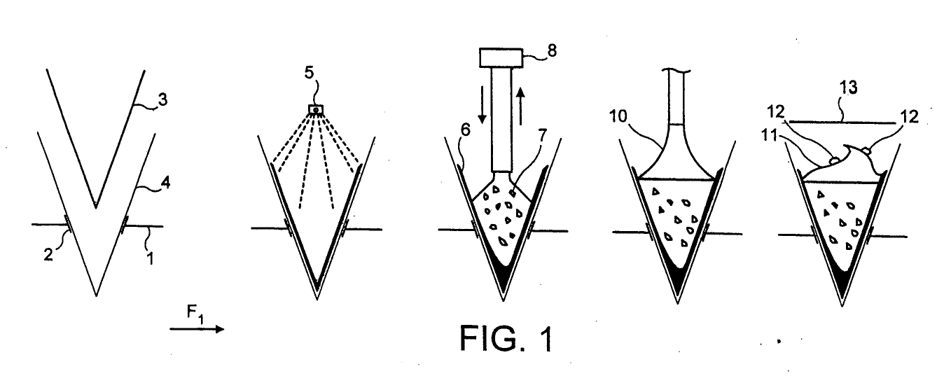

The use of the process is described below by way of nonlimiting example in combination with the accompanying drawing relating to preferred embodiment detailed in Example 1, FIG. 1 of the accompanying drawing being a schematic representation of this embodiment.

As shown in FIG. 1, to carry out the process, a conventional line of cones consisting of a table 1 consisting of supports 2 for wafer cones 3 moving along f1 is preferably used. The wafer cones are placed in casings 4, for example made of metallized paper. Using a spraying nozzle 5, the inside of the wafer cone 3 and the top edge thereof are coated with a barrier layer of fat 6, for example chocolate or compound, which serves to limit or if possible to avoid moisture uptake. The mix for the center is prepared in a tank (not shown) according to a conventional pasteurization method after homogenization and maturation at about 4° C. for about 4 h. The tank is connected to a freezer (not shown) and inclusions 7 are introduced and mixed into the mix leaving the freezer by means of a supplying device (not shown). At the outlet of the supplying device, the mix containing the inclusions is directed to the device for metering the center 8.

In operation, a distributing device (not shown), for example a feed screw, is driven in slow rotation by an external motor in mesh on the axis of the screw, for example a compressed air motor and the imperviousness may be provided for example by a lip seal on the side of the motor. The distributing device is continuously fed by the freezer, and the throughput is compared with a reference value which may generate a signal which acts on the closing of a valve and on the reduction of the speed of the pump for supplying with product coming from the freezer so as to reduce its throughput.

The advantages provided by the process compared with traditional molding processes are many:
it is possible to measure out the ice cream at the center which contains more water in the frozen state than traditionally with a corresponding improvement in the texture which is not normally found in extruded items;
the freezing time may be reduced by 30 to 50%, which allows a higher output and a better productivity of the line;
the viscosity of the ice cream is such that the inclusions which it contains, where appropriate, may be uniformly distributed without settling out as in the case of a liquid metered ice cream.
the items, by being colder, can be easily decorated and/or coated.

### EXAMPLES

The examples below illustrate the invention. In these examples, the portions and percentages are by weight, unless otherwise stated.

### Example 1

Preparation of a Frozen Cone

A mix for raspberry sorbet which constitutes the water ice in the center is prepared from the following ingredients, in the proportions indicated:

| Ingredient | % |
|---|---|
| Water | 55.5 |
| Glucose syrup | 6.32 |
| Xanthan gum | 0.18 |
| Carob gum | 0.12 |
| Trisodium citrate | 0.3 |
| Dextrose | 3.7 |
| Citric acid | 0.25 |
| Crystallized sucrose | 17.02 |
| Raspberry purée | 16 |
| Raspberry flavoring | 0.16 |
| Natural red coloring | 0.25 |

The ingredients are mixed at a temperature greater than or equal to 60° C., with stirring, until dissolution and appropriate hydration are obtained, the mix is homogenized and pasteurized and then cooled and it is allowed to mature at 4° C. with slow stirring. After passage into a freezer with aeration, a-water ice composition is obtained which has a degree of overrun of 40% and a temperature of −5 to −6° C. 20% of small pieces of crushed raspberry are added to the mass with overrun.

With reference to FIG. 1, wafer cones 3 are presented in their coverings 4 under the metering device 8.

The wafer cones 3, open at the top at −5° C. to −6° C., are filled with liquid water ice mix prepared according to 1 above by means of a distributing device at a pressure of 2 bar connected to the metering device with an immersed nozzle 8 which descends to the middle of the cavities of the cones and fills them while ascending. The filling of the cones is then completed by depositing a decoration 9 consisting of ice cream 10 in the form of a flame, which is supplemented with chocolate sauce 11 and additions of roasted peanuts 12. The whole is closed with a cover 13 which may be a small carton or a lid made of transparent plastic material.

### Example 2

Additional Frozen Cones

Frozen cones are manufactured as in Example 1, except that an ice cream decoration is placed which consists of two ice creams of different color and flavor which are coextruded and barely mixed (for example with a static mixer), producing a marbling effect.

1-11. (canceled)

12. A process for preparing a frozen confectionery item, which comprises:
shaping a wafer to serve as a mold that is open at one or both of its ends to receive the frozen confection therein;
coating a moisture barrier upon internal surface(s) of the wafer mold in an amount sufficient to retard moisture penetration of the wafer; and
introducing into the wafer mold a water ice composition having a degree of overrun of 20 to 80% to form a center of the frozen confectionery item.

13. The process of claim 12, wherein the moisture barrier is a fatty composition.

14. The process of claim 13, wherein the fatty composition comprises chocolate and optionally includes dry fruit pieces or toasted or puffed cereal particles.

15. The process of claim 12, wherein the wafer is formed in the shape of a cone.

16. The process of claim 15, wherein the center is measured out into the wafer mold by means of a distributing device provided with stirring means, combined with an immersing metering device, in that the distributing device is maintained under pressure upstream of the metering device and in that the metering device descends into the wafer mold and fills it while ascending therein, thus making it possible to fill the wafer without forming air pockets therein.

17. The process of claim 12, wherein the composition in the center is filled at −6° C. to −7° C.

18. The process of claim 12, wherein the composition in the center is introduced under pressure.

19. The process of claim 12, wherein the outer surface of the cone is provided with a chocolate coating.

20. The process of claim 12, wherein the center comprises a stabilizer selected from the group consisting of carob gum, guar gum, tara gum, carboxymethyl cellulose, gelatin, alginates, carrageenan, starches, pectins, microcrystalline cellulose, xantham gum and combinations thereof.

21. The process of claim 12, wherein the wafer is formed in the shape of a hollow tube.

22. The process of claim 12, wherein the center is manufactured by introducing inclusions having a size ranging from 0.1 to 10 mm and cooling the center prior to introduction into the wafer.

23. The process of claim 22, wherein the inclusions are selected from the group consisting of dry fruit pieces, candied fruit pieces, gel, fondant, croquant, sauce, caramel, chocolate, sweetened confectionery, biscuits and combinations thereof.
